(19) United States
(12) Patent Application Publication
(10) Pub. No.: US 2009/0319342 A1
(43) Pub. Date: Dec. 24, 2009

(54) SYSTEM AND METHOD FOR AGGREGATING AND SUMMARIZING PRODUCT/TOPIC SENTIMENT

(75) Inventors: Michael Shilman, Albany, CA (US); Rajesh Chandran, Redwood City, CA (US)

Correspondence Address: FENWICK & WEST LLP, SILICON VALLEY CENTER, 801 CALIFORNIA STREET, MOUNTAIN VIEW, CA, 94041, US

(73) Assignee: WIZE, INC., San Mateo, CA (US)

(21) Appl. No.: 12/486,344

(22) Filed: Jun. 17, 2009

Related U.S. Application Data
(60) Provisional application No. 61/074,061, filed on Jun. 19, 2008.

(51) Int. Cl. G06Q 10/00; G06Q 30/00

(52) U.S. Cl. 705/10

(57) ABSTRACT

Documents are collected from a variety of publicly available sources that contain product data including product reviews, product specifications, price information and the like. Snippets of text obtained from the documents are analyzed for relevance, sentiment, credibility and other aspects that help evaluate the quality of a product. Feature vectors are computed for snippets to analyze relevance, sentiment, or credibility. Statistical analysis is performed on the feature vectors to estimate a measure of the relevance, sentiment, or credibility. Factors associated with various snippets are aggregated to compute a quality score for a product or a particular aspect of product including product features, attributes, usages, or user personas. Information is displayed on a user interface that allows the user to examine the details relevant to computation of the quality score.

The present application claims the benefit of and priority to U.S. Provisional Patent Application No. 61/074,061 entitled “System and Method for Aggregating and Summarizing Product/Topic Sentiment,” and filed on Jun. 19, 2008, and is hereby, incorporated by reference in its entirety.

### FIELD OF THE INVENTION

This invention relates to evaluating quality of products based on different aspects of products using information available in electronic data, for example, user-contributed online content.

### BACKGROUND

Consumers like to use opinions of other people for making product purchase decisions. Conventionally, limited information sources have been available for consumers for making product purchase decisions, for example, family and friends, salespeople, and traditional print and broadcast media. The ability to access electronic data using the internet provides access to information useful for making product purchase decisions. This information is available in various forms, for example, web pages with product information, product reviews on blogs or forums, online video clips, and the like. This provides a variety of sources of information for consumers to perform research. Irrespective of the kind of product a consumer is looking for, and the purpose of the products, there is a high probability that people have already bought a product for that purpose, used that product extensively, and expressed their opinions in a publicly accessible forum.

However, while significant amount of relevant information may be available related to a product for a purpose, the information may be distributed among a large number of sources, and each source may provide its information in a different format. The diverse nature of this information makes it difficult for an individual to assemble a coherent view of the products within a product category, and narrow their purchase decision from tens or hundreds, down to a small choice set, and finally down to a single product to purchase.

### SUMMARY

Methods and systems allow evaluating the quality of a product with respect to a topic. The ranking is determined based on information available in snippets of text documents. The snippets are analyzed to determine an estimate of the relevance of each snippet to the topic, an estimate of the sentiment of each snippet with respect to the topic, and an estimate of the credibility of each snippet. An aggregate quality score of the product with respect to the topic is determined based on factors associated with each snippet including the estimates of relevance, sentiment, and credibility of the snippets.

In one embodiment, the snippets of text are obtained by aggregating documents containing information on products from online information sources. A snippet of text corresponds to a portion of the text describing a product with respect to the topic. An estimate of the relevance of a snippet is computed by identifying snippets that contain terms describing the topic and processing each snippet identified. A feature vector representing the relevance of snippet with respect to the topic is computed for each identified snippet. A relevance score for each identified snippet is determined based on statistical analysis of the feature vectors associated with the snippets. In some embodiments, the feature vector components are computed by matching patterns describing the topic.

In one embodiment, an estimate of the sentiment of each snippet with respect to the topic is determined by identifying snippets containing terms describing the topic and processing each snippet. A feature vector is computed for each snippet. The feature vector components are determined based on the sentiment described in the snippet. Statistical analysis of the feature vectors of the identified snippets is performed to determine a sentiment score for each snippet.

An estimate of credibility of a snippet is determined based on information indicative of the reliability of the information in the snippet. The estimate of credibility is determined based on factors including the credibility of the author, the credibility of the source, the feedback received from users specifying the number of helpfuls or unhelpfuls, and the size of the snippet.

The overall quality score of the product with respect to the topic is determined as an aggregate value of an estimate of votes corresponding to each snippet. The vote corresponding to a snippet is indicative of the quality of the product with respect to the topic as determined by the snippet. In some embodiments, the overall quality score computation includes other factors, for example, the age of each snippet.

The features and advantages described in this summary and the following detailed description are not all-inclusive. Many additional features and advantages will be apparent to one of ordinary skill in the art in view of the drawings, specification, and claims.

### BRIEF DESCRIPTION OF THE DRAWINGS

FIG. 1 is a high-level block diagram illustrating an example of a computer for use as a server and/or client.

FIG. 2 is a system architecture diagram illustrating the major subsystems of a system for aggregating and summarizing product/topic sentiment, in accordance with an embodiment of the invention.

FIG. 3 is a system architecture diagram illustrating the various components of each subsystem shown in FIG. 2, in accordance with one embodiment of the invention.

FIG. 4 is a flowchart of a high-level process for aggregating and summarizing product/topic sentiment, in accordance with one embodiment of the invention.

FIG. 5 is a flowchart of the process for analyzing aggregated data to compute quality metrics for products/topics, in accordance with an embodiment of the invention.

FIG. 6 is a flowchart of a process for computing the relevance score of snippets of text, in accordance with an embodiment of the invention.

FIG. 7 is a flowchart of a process for computing the sentiment score of snippets of text, in accordance with an embodiment of the invention.

FIG. 8 is a flowchart of a process for computing the credibility score of snippets of text, in accordance with an embodiment of the invention.

FIG. 9 is a flowchart of a process for computing the quality score of product/topic, in accordance with an embodiment of the invention.

FIG. 10 a graphical user interface for presenting information related to quality score of a product/topic, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

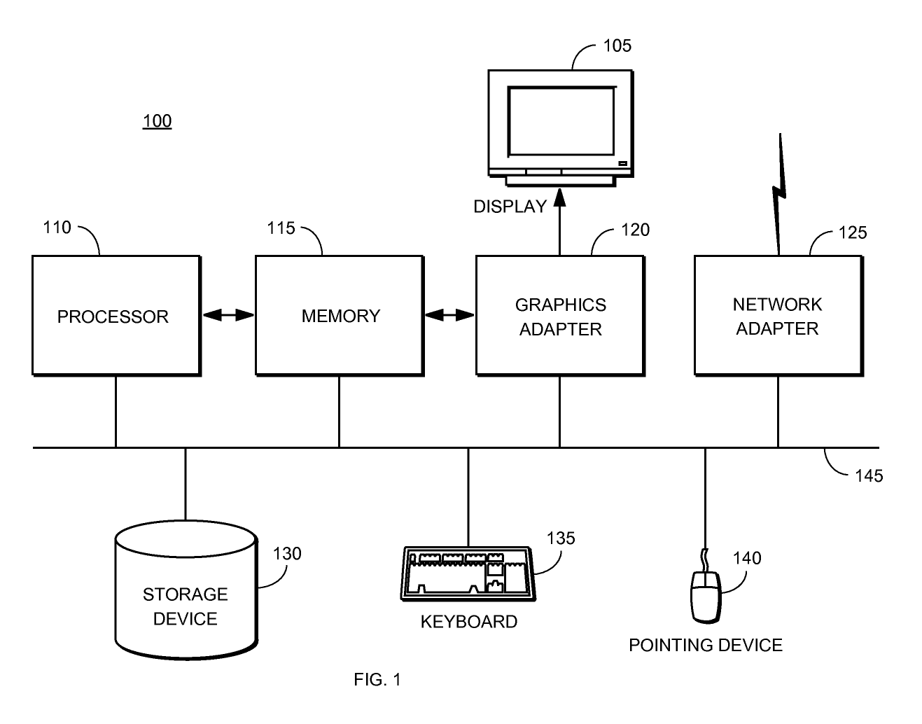

FIG. 1 is a high-level block diagram illustrating a functional view of a typical computer 100 for use as a client and/or server according to one embodiment. Illustrated are at least one processor 110 coupled to a bus 145. Also coupled to the bus 145 are a memory 115, a storage device 130, a keyboard 135, a graphics adapter 120, a pointing device 140, and a network adapter 125. A display 105 is coupled to the graphics adapter 120.

The processor 110 may be any general-purpose processor such as an INTEL x86-compatible-CPU. The storage device 130 is, in one embodiment, a hard disk drive but can also be any other device capable of storing data, such as a writeable compact disk (CD) or digital video disk (DVD), or a solid-state memory device. The memory 115 may be, for example, firmware, read-only memory (ROM), non-volatile random access memory (NVRAM), and/or random access memory (RAM), and holds instructions and data used by the processor 110. The pointing device 140 may be a mouse, track ball, or other type of pointing device, and is used in combination with the keyboard 135 to input data into the computer system 100. The graphics adapter 120 displays images and other information on the display 105. The network adapter 125 couples the computer 100 to a network.

As is known in the art, the computer 100 is adapted to execute computer program modules. As used herein, the term “module” refers to computer program logic and/or data for providing the specified functionality. A module can be implemented in hardware, firmware, and/or software. In one embodiment, the modules are stored on the storage device 130, loaded into the memory 115, and executed by the processor 110.

The types of computers 100 utilized in an embodiment can vary depending upon the embodiment and the processing power utilized by the entity. For example, a client typically requires less processing power than a server. Thus, a client can be a standard personal computer system or handheld electronic device. A server, in contrast, may comprise more powerful computers and/or multiple computers working together to provide the functionality described here. Likewise, the computers 100 can lack some of the components described above. For example, a mobile phone acting as a client may lack a pointing device, and a computer acting as a server may lack a keyboard and display.

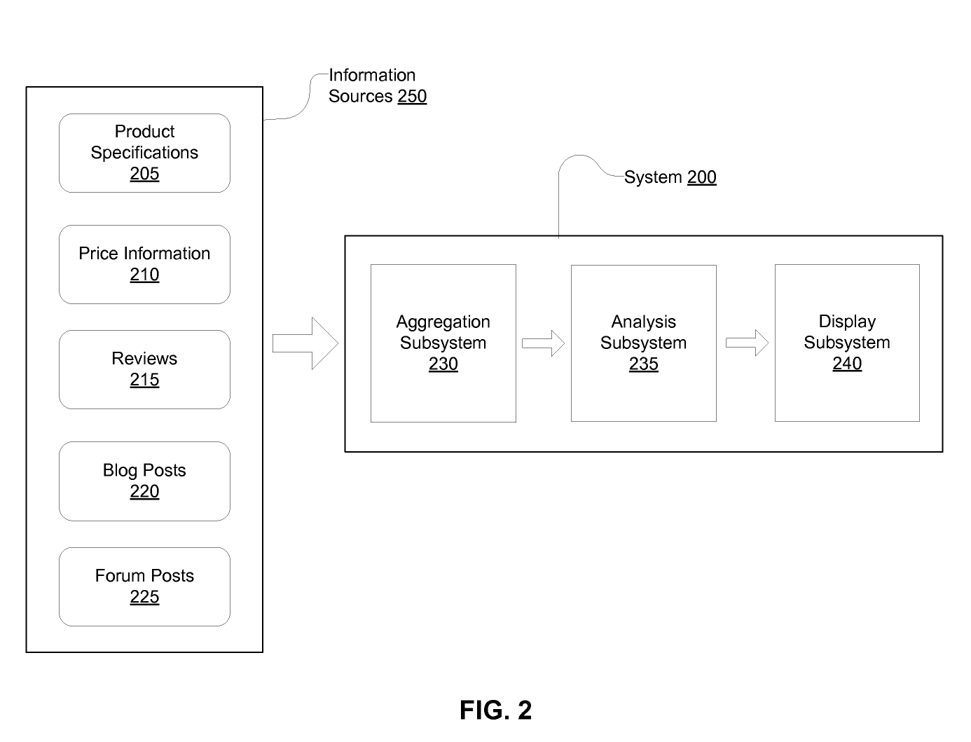

FIG. 2 presents the major subsystems of a system 200 for aggregating and summarizing product/topic sentiment, in accordance with an embodiment. The subsystems can also be called modules. The aggregation subsystem 230 collects diverse product information from various information sources 250 that may be distributed, for example, across the world wide web (“web”). Examples of information sources 250 include product specifications 205, price information 210, reviews 215, blog posts, 220, or forum posts 225. Other examples of information sources include status messages posted by member's on a social network, shared annotations of users such as bookmarks, news articles, and the like. Processing the information obtained from different information sources across numerous product categories is challenging since there is no single representational standard used across web sites for representing the information and the information is constantly changing. The accuracy of the analysis of the quality of a product typically improves with the volume and diversity of data used for processing. More, diverse data results in better estimation of customer satisfaction, sentiment and better coverage of products across the internet.

Relevant pieces of the information are extracted from the data retrieved from the diverse set of sources and stored. For example, when retrieving a product-related blog post, the aggregation subsystem 230 may store the text of the blog posts, but may not store the blog navigation headers or advertisements on that web page. Product information gathered by aggregation may be normalized into a single unified representation. For example, a product may be mentioned by a variety of names and nicknames across the diverse information sources 250. Each distinct product may be assigned a unique identifier. Each product is associated with a product category as well as with the information collected about the product.

The analysis subsystem 235 utilizes the gathered information to rank products based on quality or by a topic (described below). Products can be ranked based on their overall quality as determined by collective quality judgment of the product given a collection of product reviews. Products can be ranked based on certain aspects of the product called a topic, for example, product features, attributes, usages, or user personas. For example, a particular digital camera may be particularly lightweight and compact, but have terrible battery life. Alternatively, product quality can be ranked based on suitability of the product for a particular usage or task. For example, a camera that is highly suitable for underwater photography may not be suitable for portraiture, and vice versa. Products can be ranked based on suitability of the product for a particular type of user (also referred to as persona). For example, a camera that is suitable for a professional photographer may not be suitable for a first time user, and vice versa.

The display subsystem 240 presents the analyzed information to the user in a user interface. The user interface allows users to easily filter down products by price, features, attributes, uses, personas. For example if a user is looking for a 5.0 Megapixel camera that costs less than $200, has great battery life, and is good for moms, the user interface allows users to filter on all of these aspects of the product. The user interface allows users to compare products according to various criteria. In the example above, if a user has that set of criteria and is trying to decide between three different candidate products, the user can compare the candidate cameras with respect to the criteria used for selecting the cameras. The user interface allows the user to browse the individual detailed opinions behind the summary quality judgments corresponding to the rankings. For example, if a user wants to know why a camera rates well for moms, it is easy to filter into the reviews and posts that describe moms' experiences with the camera (positive sentiment, negative sentiment, or all).

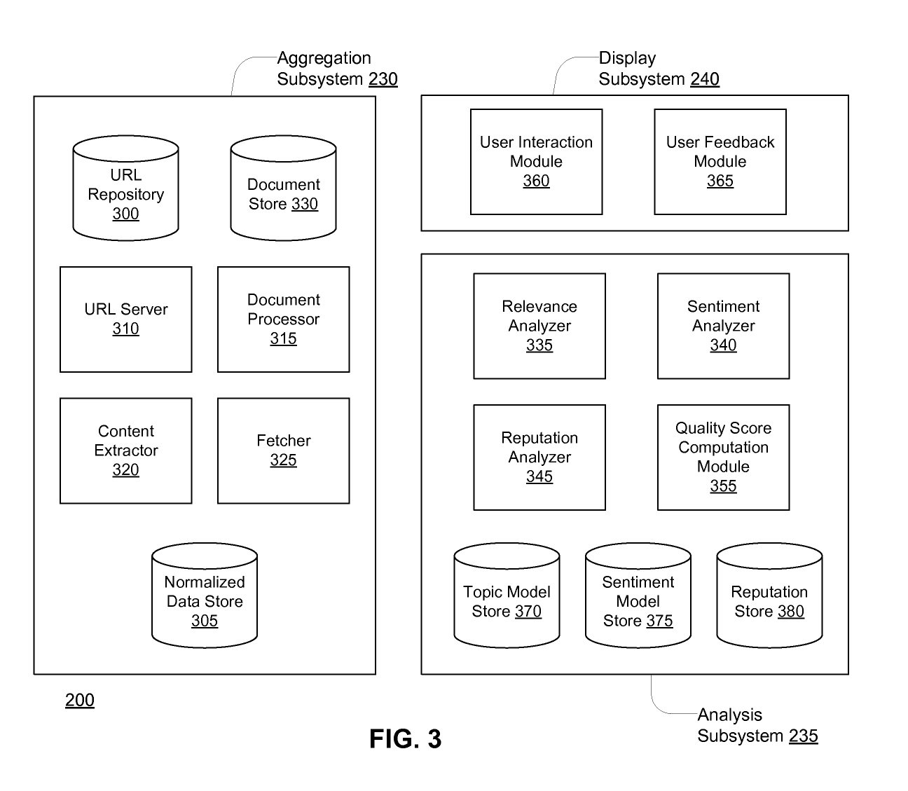

FIG. 3 shows a system architecture diagram illustrating various components of the system 200, providing details of various subsystems shown in FIG. 2, in accordance with one embodiment of the invention. The aggregation subsystem 230 includes a uniform record locator (URL) repository 300, a document store 330, a normalized data store 305, a URL server 310, a document processor 315, a fetcher 325, and a content extractor 320. A system 200 may run multiple instances of certain components, for example, URL servers 310, fetchers 325, document processor 315, or document stores 330 for scalability or reliability purposes.

The URL repository 300 contains lists of URLs that the system 200 tracks. The URLs are either provided as seed URLs as starting points for fetching web pages or populated by document processor 315. The URL server 310 defines the sequence and timing with which web pages are acquired by fetcher 325. The URL server 310 uses various metrics for defining the sequence and timing including frequency of changes, newness of products and pre-computed trends in arrival of new content (such as reviews and price-updates) based on the lifespan of the product in question. For example, new products tend to get more reviews during a period soon after its release date, depending on the type of product, whereas older products are less likely to have new reviews. The URL server 310 performs URL normalization and minimization based on comparison of different URLs and their contents. URLs pointing to similar content can be merged into a simpler representation of the URLs. The fetcher 325 acquires URLs from the URL Server 310, issues hyper text transfer (HTTP) protocol requests to the URL acquired and deposits the retrieved page content in the document store 330. The document store 330 allows fast storage and lookup of page content based on normalized URLs. In one embodiment, fast lookup can be achieved by hash-based or other indexing of the page content. The document store 330 allows documents to be annotated by document processors 315. The document processor 315 examines documents in the document store 330 and extracts and/or augments the documents examined. The document processor 315 may perform functions including content extraction, URL extraction (acquire new URLs to be places in the URL Repository 300). The normalized data store 305 contains a cleaned representation of the data acquired from the web suitable for consumption by the analysis subsystem 235 and display subsystem 240. The content extractor 320 extracts content relevant to computing quality scores for products that may be presented to the user. The content extractor keeps the extracted content updated since websites may change their structure and user generated content may move from page to page due to new content, editing, etc.

The analysis subsystem 235 includes a relevance analyzer 335, a sentiment analyzer 340, a reputation analyzer 345, a quality score computation module 355, a topic model store 370, a sentiment model store 375, and a reputation store 380. The topic model store 370 contains information specific to each topic useful for determining a score useful for ranking products that match the topic. For example, a topic “GPS for Automobiles” (GPS is global positioning system) may contain terms “car,” “driving,” and “hands free” as terms for determining if a snippet of text is relevant to the topic. The quality of the topic model can determine the accuracy of the relevance score. The topic model can contain a set of patterns that match the input. It can contain a regular expression for a set of text patterns to match in the input, a set of valid values for the snippet or product metadata (e.g., only two-seat strollers are relevant to the topic “twins”), and so on. These patterns can be entered by humans or inferred from a secondary source such as a thesaurus (the presence of the pattern “automobile” should also signify relevance to the topic “car”). There is also a large collection of standard patterns (such as N-grams, alone or combined with part of speech tags), that can be applied to the inputs.

The sentiment model store 375 contains information useful for determining the sentiment of a snippet of text towards a product. For example, the terms “great” and “awesome” correspond to positive sentiment, whereas the terms “I hate”, “terrible” correspond to negative sentiment. The reputation store 380 keeps information useful for evaluating credibility of snippets based on credibility of sources of information and users. The relevance analyzer 335 computes a relevance score of snippets for ranking the snippets based on their relevance to a topic. The sentiment analyzer 340 determines a sentiment score of a snippet based on information available in the sentiment model store 375. The sentiment score provides a measure a positive or negative likeness towards a product topic based on information available in a snippet. The reputation analyzer 345 determines a credibility score for a snippet based on information available in the reputation store 380. The topic model store 370 and the sentiment model store 375 can be populated by experts. Alternatively, the topic model store 370 and the sentiment model store 375 can be populated using machine learning techniques. For example, an embodiment processes all words (unigrams) in a set of documents, learns the weights for each word, and then eliminates the words whose weights are close to 0, resulting in a set of words of interest to a model. For example, for sentiment, the word “great” might be assigned a weight of 0.8, the word “terrible” assigned a weight of −0.8, and the word “gear” assigned a weight of 0.001. Similarly, for a relevance model “cameras for vacation”, “vacation” and “trip” might have positive weights, “home” might have a negative weight, and “camera” might have a weight close to zero. The classifier can take a weighted sum of the presence or absence of words (0 if absent, 1 if present), to classify the snippet. The above example presents a simplified model for illustration purposes and real world models can be more sophisticated. If snippets in the query that contain the highly-positively weighted unigrams are considered, a good set of snippets is obtained for consideration.

The display subsystem 240 includes a user interaction module 360 and a user feedback module 365. The user interaction module 360 presents the information generated by the analysis subsystem 235 to a user. The user may provide input using the user interaction module 360 to indicate the topics that the user is interested in. The user feedback module 365 allows a user to input information useful for learning for improving the models stored in topic model store 370, sentiment model store 375, and normalized data store 305. For example, a user may provide information indicating that the quality score determined for a product topic is incorrect and in the opinion of the user, the score should be another value. The feedback is used to correct parameters used in the analysis subsystem 235 so as to improve future results.

The document processor 315 implements parsers to annotate documents with additional metadata such as “likely product name or model number.” The parsers use pattern-based techniques, including a combination of regular expressions and hypertext markup language (HTML) document object model (DOM) navigation rules. Regular expressions/DOM navigation rules are a set of hand-coded patterns used to extract content such as reviews from a given page. Each expression or navigation rule is associated with a (website-identifier, page-type) combination such that website-identifier is information that identifies a website, for example, a website's URL and page-type refers to a category of pages, for example, product pages or product-list pages on a retailer's website. For example, for a retailer's website with URL www.acme.com (website-identifier, page-type) combinations can be (www.acme.com, product-page) and (www.acme.com, product-list-page). Similarly, for a different website www.acme2.com (website-identifier, page-type) combinations can be (www.acme2.com, product-page) and (www.acme2.com, product-list-page). The extracted data is annotated with its type, for example, “product name,” “model number,” “product category,” “review text,” “specification name/value,” etc. The document processors 315 use pattern-based techniques to identify and store content containing additional metadata in the normalized data store 305. The document processor 315 applies statistical classification mechanisms such as Naïve Bayes classifier, regression, etc. to this content augmented with metadata to build a classifier for each type of data. One embodiment uses Hidden Markov Models for content specific to user sentiments in relation to products. Given a new web page, its content can be pre-processed to eliminate HTML tags and leave a collection of phrases or sentences. This content can then be fed into the above classifiers. For each such classification, the system assigns a confidence level (e.g., 0.0 through 1.0). If the confidence level is beneath an empirically-determined product-category and content-type dependent threshold, the content can be queued-up for a manual extraction by a human. This extracted content is fed back into the analysis phase.

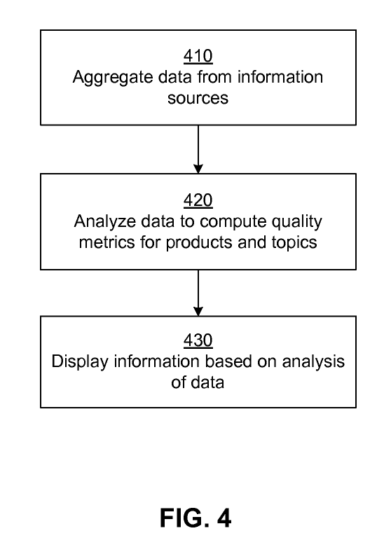

FIG. 4 shows a flowchart of a high-level process of the system 200, in accordance with one embodiment of the invention. The aggregation subsystem 230 aggregates 410 the data obtained from various information sources 250. The analysis subsystem 235 analyzes 420 the information aggregated 410 to compute quality metrics for products and topics. The display subsystem displays 430 the results of the analysis 420 to the user. In some embodiments, information displayed 430 to the user allows the user to investigate and see information showing how the results were obtained as well as provide feedback on the quality/accuracy of the results in the opinion of the user. The various steps of FIG. 4 are described in detail herein.

### Aggregation of Data

In one embodiment, the content extractor 320 performs normalization of the content available by identifying the specific product or class of products referenced for each of the labeled documents. The identification of a product referenced by a text is made difficult by the different ways people refer to products (including retailers, model number, variations in minor attributes, nicknames, stock keeping units (SKUs), etc.). The input data can be highly unstructured and websites, esp. smaller website may not adhere to standardized naming schemes. Techniques used for identifying the product referenced by a labeled document include the use of a matching rules engine and manual matching. A set of matching rules such as “model number matches a known product,” “technical specifications match a known product,” “release date is close to a known product,” etc. can be evaluated on a newly extracted document. Each such result can be assigned a confidence value (e.g., 0.0 to 1.0) used to judge the overall confidence of the match. Some embodiments may use an inverted index on key attributes of known products (such as names and model numbers) to speed-up matching. If the confidence level is below a predetermined threshold, the content can be presented to human supervisors. The supervisor is presented with the labeled content of the new page and a list of possible matches which the supervisor can use to determine a match against the existing product catalog or to create a new product. If a match to a product already in the catalog is found, there may be conflicting data acquired from different sources. The conflicts are resolved by assigning a credibility value to the sources. When a new source appears in the system, its credibility is adjusted upwards or downwards based on the correlation of its data with known sources. The credibility values of sources may be periodically audited by a human supervisor. The normalized representation of all product and related data used as input by the analysis subsystem 235 and display subsystem 240 is stored in the normalized data store 305. In some embodiments the documents stored in the normalized data store 305 correspond to text snippets corresponding to one or more sentences or paragraphs.

### Relevance Analysis

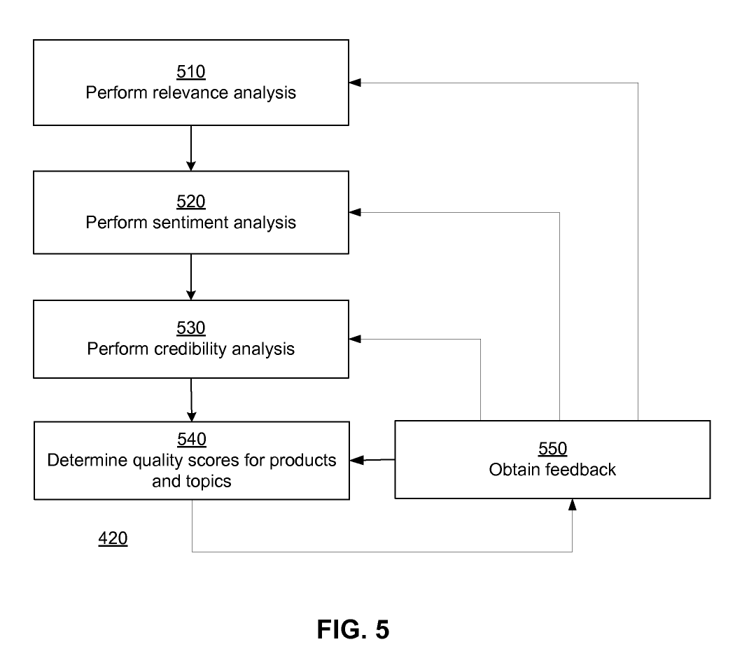

FIG. 5 shows the overall steps of analysis 420 of the information aggregated 410 from the information sources 250. The analysis determines a quality score of the product providing an overall quality assessment of the product based on information related to the product available in the snippets collected. The analysis also determines topic scores for topics related to a product providing quality assessment of the product with respect to a set of product features, attributes, usages, or user personas. In one embodiment, given a topic, a set of products, a set of reviews (or any other text) that discusses those products, and a set of metadata about the products such as prices and specifications, the analysis determines a normalized score (e.g. ranging from 0 to 100) for each product with respect to the topic. The score can be used to rank-order the products for that topic. The results of the analysis help users filter and compare products to determine the right product for their needs and preferences.

The relevance analyzer 335 analyzes 510 relevance of a snippet to a product/topic and determines a relevance score to the snippet indicating how relevant the snippet is for the topic. A product can have any number of text snippets associated with it, for example, user or expert reviews about the product, blog or forum posts, articles, and so on. A snippet can be of any size, including a posting, a paragraph of a posting, a sentence, or a phrase that is smaller than a sentence. Each snippet may or may not mention the topic in question. For example, if the topic is “Digital Cameras for Sports,” a snippet that mentions how the author used the camera to photograph a hockey game would be relevant to the topic. Similarly, a snippet that talks about the camera's ability to capture fast-moving objects or action shots would be relevant. A snippet that focuses on the camera's battery life or ease of use for family portraits may not be relevant to sports.

The sentiment analyzer 340 performs sentiment analysis 520 to determine a sentiment score for a snippet with respect to a product/topic indicating the sentiment of the snippet for the topic. Given a set of one or more text snippets associated with a product, the sentiment analysis 520 determines whether the sentiment or disposition of those snippets is positive, negative, or neutral. In the example above, the snippet that mentions that the author used the camera to photograph the hockey game might be declaring how well it worked to capture the game, how she was disappointed in its performance, or simply that she used it without stating the outcome. Sentiment can either be represented as a set of buckets (e.g. positive, neutral, negative, or perhaps more granular “somewhat positive”, “somewhat negative”), or as a continuous scale ranging from negative to positive, representing degree of preference.

The reputation analyzer 345 analyzes 530 credibility of documents to determine a credibility score for a snippet. In some embodiments, the credibility score is associated with the snippet whereas in other embodiments the credibility score is associated with a combination of snippet and topic. The credibility of a snippet is analyzed based on factors including credibility of the author and the credibility of the source of document. For example, a snippet that comes from the manufacturer of the product may be less trustworthy because the author is heavily biased in favor of their product. Similarly, a well-known reporter writing a full product review may be more trustworthy than a stranger writing that a product “sucks” without substantiation. On some product review sites, users can mark a review as “helpful” or “not helpful,” and this can also contribute to the reputation of that snippet or to the author behind that post.

Given a set of snippets that are relevant to a topic and express some sentiment towards the topic, an aggregate quality score is determined 540 by the quality score computation module 355 for each product with respect to a topic. Intuitively, each snippet that is relevant to a topic and expresses positive disposition towards that topic can be considered a “vote up.” Similarly each relevant, negative snippet is a “vote down”. The aggregate score is computed based on a various factors including the relevance score of the snippet, the sentiment score of the snippet, and the credibility score of the snippet. Further details of the computation of the quality score are provided herein. The steps 510, 520, and 530 may be performed in any order to provide the results for computation 540 of the quality scores unless a particular embodiment requires results of one step for computing another step.

Feedback is obtained 550 by various mechanisms to improve the quality of the scores computed by the system 200. In one embodiment, the user interaction module 360 generates displays to show the scores related to product/topics and snippets to an end user of the system, or to a curator who is responsible for ensuring that the system produces high quality results. Based on the displays, users contribute feedback to the system that is incorporated by user feedback module 365. The system 200 adapts to this feedback and learns to produce better results. For example, relative product quality can be displayed as a ranked list. Users can browse these visualizations, and if they disagree with ranking, they can provide feedback to the user feedback module 365, for example by proposing that a product should be voted up or down in the ranking. This kind of feedback can be used to improve the computation of the quality score of the products/topics of processing, because the system learns to produce better scoring according to this information.

Users can also browse the individual snippets used for determining the ranking. A review that describes how a camera “captures the light beautifully” may be mistaken for a review that is relevant to the “weight” of the camera. A user can mark this snippet as “irrelevant” to the “weight” topic, and can mark it as “relevant” to the “picture quality” topic. Similarly, a snippet that declares “I hated how the camera took pictures indoors until I discovered its low-light setting,” may be mistaken for a very negative sentiment because of the phrase “I hated.” Users can correct the system's sentiment estimation by marking a snippet as “positive,” “negative,” or “neutral,” and the system learns from the correction to produce more accurate relevance and sentiment estimations. Details of the learning process are described herein.

In some embodiments, implicit feedback can be obtained from user actions. For example, if a list of products is presented to a user for a given topic, a click through user action indicating the user was interested in more information on a product is indicative of a positive feedback. On the other hand a user ignoring the highest ranked product and retrieving information for a lower ranked product may be considered an indication of negative feedback for the highest ranked product. In one embodiment, computation of the credibility score of a snippet can provide feedback for evaluation of the credibility score of the author. For example, an author providing several snippets that achieve low credibility score can be assigned a low author credibility score. The feedback obtained 550 from users or other means can be provided as input to a single step of the process in FIG. 5, for example, the relevance analysis 510 or the sentiment analysis 530 or the feedback can go to multiple steps. In one embodiment, a user interface is provided to the users, allowing them to click-through on a snippet to see its entire review. A click-through from a user is an indication of the relevance of the snippet since the user showed interest in the snippet.

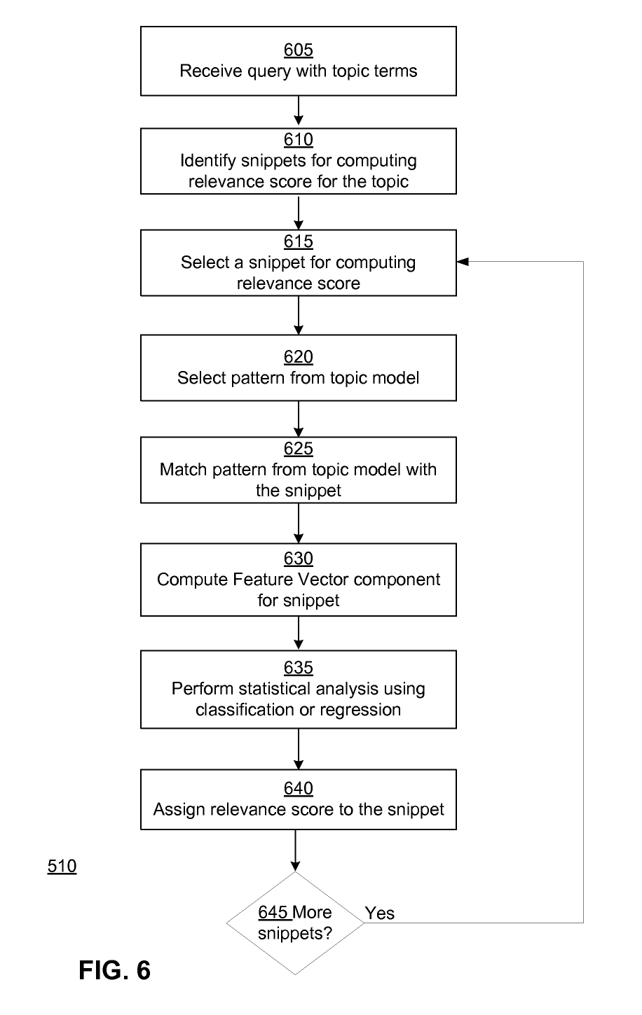

FIG. 6 shows a flowchart of a process executed by the relevance analyzer 335 for performing 510 relevance analysis/computing the relevance score of snippets of text, in accordance with an embodiment of the invention. The analysis of a snippet can be considered similar to “voting” in which text snippets relevant to the topic weigh in on the final score. The relevance score of a snippet is indicative of whether or not a text snippet is relevant to the topic. The process of relevance analysis 510, identifies a text snippet, metadata about the text snippet (author, source, date posted, review score, etc.), and metadata about the product as its input. The process uses a topic model, which represents knowledge about the topic. The relevance analysis determines an estimated degree of relevance of the snippet to the topic.

As shown in FIG. 6, a query is received 605 by the user interaction module 360 from a user. The query provides terms from a topic. The relevance analyzer 335 identifies 610 snippets relevant to the topic. In one embodiment, all available snippets are used for computing the relevance score of any topic. However, in a system with a large number of snippets, it may be inefficient to examine each and every snippet for each topic. In this situation a subset of snippets can be used for computing the relevance score for a topic. In one embodiment, the relevance analyzer 335 uses queries based on terms from the topic model to compute a subset of the snippets. For example, the highest weighted n-grams from the topic model may be used to compute a subset of snippets used for computing the relevance score for a topic. The subset computed by querying the highest weighted terms can be further refined by using other terms from the topic mode. The resulting subset of snippets may have significantly less number of snippets. Because this technique of applicability analysis is a general technique for detecting whether a sentence is relevant to a topic, the technique can also be applied to spotting product references in reviews. Consider a particular product, such as the MOTOROLA RAZR camera. References to this product might include strings that contain “Motorola RAZR”, “Moto”, “RAZR”, “V3” (a popular revision), etc. In order to “spot” these products in snippets of text a model is built that recognizes strings that might refer to the specific product. The learning techniques described herein can also be applied to spotting references to products in snippets.

Given the subset of snippets relevant to a topic, the relevance analyzer 335 analyzes each snippet for computing the contribution of the snippet to the relevance score of the topic using steps 615-630. A relevance analyzer 335 selects 615 a snippet, selects 620 patterns from the topic model and matches 625 the pattern from the topic model with the snippet. For example, in the simple case of a topic model with a single word “car,” any text snippet that contains the word “car” could return a relevance of 1, and any snippet that does not contain the word “car” return a relevance of 0. In general, when multiple factors are considered for computing relevance of each snippet, the relevance analyzer computes 630 a feature for the snippet. Each component of the feature vector may be determined by one factor used for computing relevance of the snippet. In some embodiments, the steps 615 and 620 can be considered optional since they represent a particular embodiment of the computation of components of the feature vector corresponding to the snippet.

In some embodiments, the relevance analyzer 335 uses one or more of these criteria for computing components of feature vectors for each snippet: (1) Presence or absence of any of a set of one or more hand-specified regular expressions for that topic. (2) Presence or absence of the most frequent K unigrams, bigrams, and trigrams (K=10,000). (3) Presence or absence of the most frequent K unigrams, bigrams, and trigrams annotated with part-of-speech information, as computed using an off-the-shelf part of speech tagger (K=300). (4) Matching of the product metadata to any of a set of boolean predicates on product metadata (“type=DSLR AND (price<1000 OR brand=Acme)”). Other criteria can be considered for evaluating the relevance score, for example, heuristics such as length of snippet, a scalar value based on the length of the snippet, the number of instances of a phrase in a snippet, a measure of the proximity of a phrase to the start or the end of the snippet, the value of product attributes. In general, any boolean expression on the comparison of any scalar feature to a predefined threshold, set predicates on product metadata, presence or absence of phrases in the body of the text, part of speech tags, parse tree tags, and so on. Stemming can also be applied to the words. Stemming is the process of reducing a word to its root form, and reduces the size of the feature space by a factor. For example, “inflating,” “inflation,” “inflates,” and “inflate” may all reduce to the same root “inflat.” This makes it easier for the system to learn. Many stemming algorithms are available in references including (1) Porter, M. F. (1980) An Algorithm for Suffix Stripping, Program, 14(3): 130-137, (2) Krovetz, R. Viewing Morophology as an Inference Process, Annual ACM Conference on Research and Development in Information Retrieval, 1993, (3) Lovins, J. B. Development of a Stemming Algorithm. Mechanical Translation and Computational Linguistics 11, 1968, 22-31, (4) Lancaster stemming algorithm available on the world wide web at www.comp.lancs.ac.uk/computing/research/stemming/index.htm, (5) Jenkins, Marie-Claire, Smith, Dan, Conservative stemming for search and indexing, SIGIR 2005, which are all incorporated by reference herein in their entirety. Because stemming reduces information, an embodiment uses a conservative stemming that heuristically depluralizes words and has an extensible dictionary of hard-coded stemming rules.

The feature vector computed 630 can be a vector with binary components (0's for each pattern that did not match the input, 1's for each pattern that did), or can be continuous (each entry is the number of times the pattern matched the input). In one embodiment, a single N-dimensional vector is computed per snippet and statistical analysis techniques are used for further processing 635. The model contains a learned weighting for how these patterns contribute to the relevance score. As users correct the output of the analysis, the weighting is updated to become more accurate. There are many possible weightings and update methods which can be utilized by the mode, for example, classification and regression, using techniques such as Bayesian Networks, Decision Trees, Support Vector Classification, Linear Regression, Support Vector Regression, Neural Networks, Boosted Decision Trees, etc. The statistical analysis technique of choice is applied to the given feature vector to assign 635 a score or discrete classification to the snippet (which can be converted into a score, e.g., irrelevant=0, partially relevant=0.5, highly relevant=1).

### Sentiment Analysis

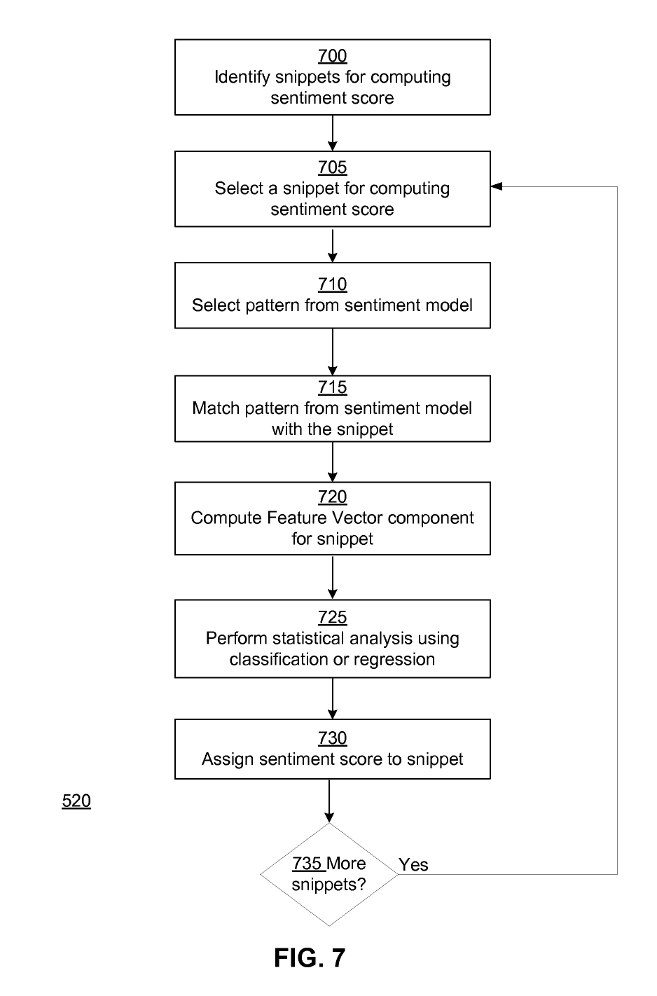

FIG. 7 shows a flowchart of a process used for performing 520 a sentiment analysis/computing the sentiment score of snippets of text, in accordance with an embodiment of the invention. A sentiment model containing input patterns (features) and a weighting scheme is applied to the input data to produce a score assessment. In one embodiment, sentiment and relevance analysis are combined into a single process, such that the steps of sentiment analysis are executed together with the steps of relevance analysis by a single module, for example, the relevance analyzer 335. In another embodiment, sentiment analysis is computed as a separate process comprising steps specific to sentiment analysis executed by the sentiment analyzer 340. Separating the two processes has practical benefits, for example, the relevance analysis can be performed for each topic, whereas the sentiment analysis can be performed for a category of topics or at a global level since the way people express positive and negative sentiment (“great”, “awful”, etc.) does not differ greatly between topics. The sentiment analyzer 340 can perform sentiment analysis at different levels of granularity: (1) for each topic, (2) for a topic category, (3) for all topics at a global level, (4) combinations of the first three model so as to get the best approach for a given context. Mechanisms of combining classifier results include: (1) computing a weighted sum of the outputs, and determining the weights empirically, (2) feeding the input into a neural network (or any other classifier), and learning the weights/meta-model automatically, (3) making each algorithm return a confidence in addition to its weight and computing a weighted sum by confidence, (4) feeding the outputs and confidence into a learning algorithm like neural net. Furthermore, user-corrected (labeled) snippets for all degrees of sentiment can be used to train the topic model, and snippets from all topics can be used to train the sentiment model.

As shown in FIG. 7, the sentiment analyzer 340 identifies 700 snippets for computing sentiment scores. The set of snippets identified can be the entire set of snippets or a subset of snippets. For example, a subset of snippets relevant to the topic as computed by the relevance analyzer 335 using the flowchart in FIG. 6 can be identified 700 as the set of snippets for computing sentiment score. The sentiment analysis can be performed offline as a batch process or can be performed on the fly when a user request comes in. Performing sentiment analysis in advance using a batch process improves the performance of online requests since there is less computation performed when a request comes. The sentiment analyzer 340 selects 705 a snippet, selects 710 a pattern from the sentiment model and matches 715 the pattern with the snippet selected. In some embodiments steps 710 and 715 are considered optional allowing alternative mechanisms to be used for evaluating the sentiment of the snippet. Mechanisms used by the sentiment analyzer 340 for evaluating sentiment of a snippet include: (1) Presence or absence of the most frequent K unigrams, bigrams, and trigrams (K=10,000). (2) Presence or absence of the most frequent K unigrams, bigrams, and trigrams annotated with part-of-speech information, as computed using an off-the-shelf part of speech tagger (K=300). (3) Quantized overall quality score of a product (into K=10 buckets). The quality score of a product impacts sentiment analysis because if a product is generally loved by its users, the chances are high that any given snippet about the product is positive. (4) Quantized score of the review under consideration (into K=10 buckets), for example, a review with low credibility may not be considered significant from sentiment analysis point of view. Other criteria can be considered for evaluating the sentiment score, for example, heuristics such as number of instances of a word in a snippet, and conjunctions or disjunctions between N-gram features. The sentiment analyzer 340 combines the values computed by various mechanisms for quantifying the sentiment of the snippet as components of a feature vector to compute 720 a feature vector corresponding to the snippet. The sentiment analyzer performs 725 statistical analysis and assigns 730 a sentiment score for the snippet, for example, using classification or regression techniques. If more unprocessed snippets are available 735, the sentiment analyzer 340 repeats the steps 705-730 for the unprocessed snippets.

### Reputation Analysis

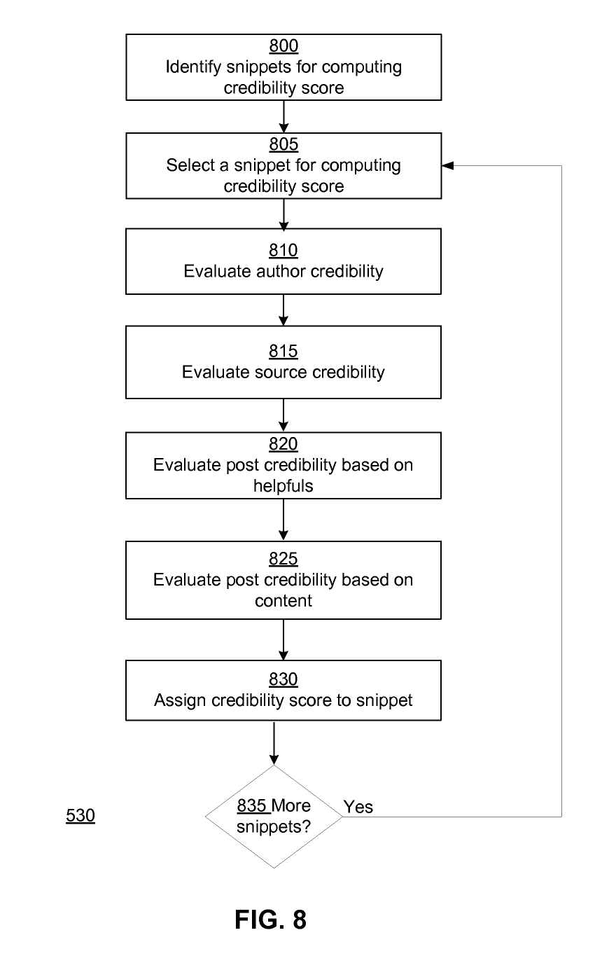

FIG. 8 shows a flowchart of a process executed by the reputation analyzer 345 for performing 530 a credibility analysis/computing the credibility score of snippets of text, in accordance with an embodiment of the invention. Snippets are identified 800 for computing their credibility scores. In one embodiment, the credibility analysis is performed for the entire set of snippets. In another embodiment, credibility analysis is performed for the subset of analysis computed by relevance analysis 510. Credibility analysis utilizes a learned model to estimate the trustworthiness of a post or author. However, the estimation can be based more on metadata about the post and author than about the content of the post itself (though content is also considered). In an embodiment, credibility analysis of snippets is performed as a batch process that is executed offline. In another embodiment, credibility analysis is performed on the fly when a user request comes in. Performing credibility analysis in advance using a batch process improves the performance of online requests since the amount of computation performed when a request comes in is less. The reputation analyzer 345 selects 805 a snippet from the identified snippets for computing its credibility score. The credibility of the snippet is evaluated based on various factors.

The reputation analyzer 345 evaluates 810 credibility of the author of the snippet. The number of posts from an author can skew the author's credibility. If an author has many posts that are mostly credible, the author's credibility is increased. If an author has many posts that are less credible, the author's credibility can be decreased. Similarly, if the author's opinions consistently disagree with the consensus, the author's credibility can be decreased. In one embodiment, the feature corresponding to the author's credibility is represented as a histogram (number of buckets K=3) of the number of credible posts from that author. So if an author has 1 post with a credibility of value of <0.33, 3 posts with credibility between 0.33 and 0.66, and 7 posts with a credibility value of >0.66, the author credibility features is (1, 3, 7).

The reputation analyzer 345 evaluates 815 the credibility of the source. The source on which the post was created can have significant effect on the post credibility. When a source consistently disagrees with the rest of the world, or when it consistently has low-credibility posts, its credibility is lowered, and in turn, the credibility of its posts is lowered. In one embodiment, the source credibility is modeled with four features. The first feature is the distance between the distributions of review scores for that particular source from the distribution of review scores for all posts. This can be modeled using Kullback-Leibler divergence or other statistical difference measures. The second, third, and fourth features are the same as the author credibility measures, but using the reviews from the source as inputs, rather than the reviews from the author.

The reputation analyzer 345 evaluates 820 the credibility of the post based on helpfuls. A helpful represents feedback by users of the system marking a review as “helpful” or “not helpful.” When available, helpfuls provide a useful measure of credibility for a post. This information may not be available for several posts. When this information is available, it is a good proxy for credibility, and can be used to train a model of the relative importance of the other factors. The feature corresponding to the helpfuls can be represented as a discrete value corresponding to the number of helpfuls of a post. If a post has 5 helpfuls, the value will be 5. The number of helpfuls and the number of unhelpfuls are represented as separate components. This results in a general representation that allows a learning algorithm to learn intelligent combinations of the two values independently.

The reputation analyzer 345 evaluates 825 the credibility of the snippet based on the content of the post from where the snippet is obtained. The text content of a post can be an indicator of credibility, for example, the length of the post is proportional to its credibility. Longer posts typically indicate more interest in the subject and more credibility. The choice of wording can also affect credibility. The choice of words (as modeled by N-grams) can predict post credibility better than random. On its own, this may not be enough to be reliable, but when combined with the other factors, it improves system accuracy. In one embodiment, the frequency of the top N-grams, for example, the top 10,000 unigrams is used as a measure of the posts credibility. Higher the frequency of the n-grams, higher the credibility of the post.

The reputation analyzer 345 can execute the steps 810, 815, 820, and 825 in any order. The reputation analyzer 345 evaluates the credibility of snippets while there are more unprocessed snippets available 835 from the identified snippets. The problem of evaluation of the credibility of snippets is modeled as a regression problem. The output of the regression can also be used as an input to the regression, for example, the author credibility is based on the credibility of various posts. Hence, the reputation analyzer 345 can perform the computation iteratively, by setting initial values for the inputs of [0, 0, 0] for both the author and source post credibility (the Kullback-Leibler divergence can be computed a priori).

The post credibility is computed for all authors within a source, the author/source credibility values updated, and the process repeated. This process may take a large number of iterations to converge to a fixed point (e.g. posts that are less credible lower the credibility of their source/author, which in turn lowers their own credibility, etc.). A fixed number of iterations, for example 2 iterations of the computation can be performed as a heuristic approximation to this value. Alternative embodiments use other approaches, for example, computing the source/author credibility values for all sources/authors, ranking the sources/authors, and quantizing the results into buckets.

### Quality Score Computation

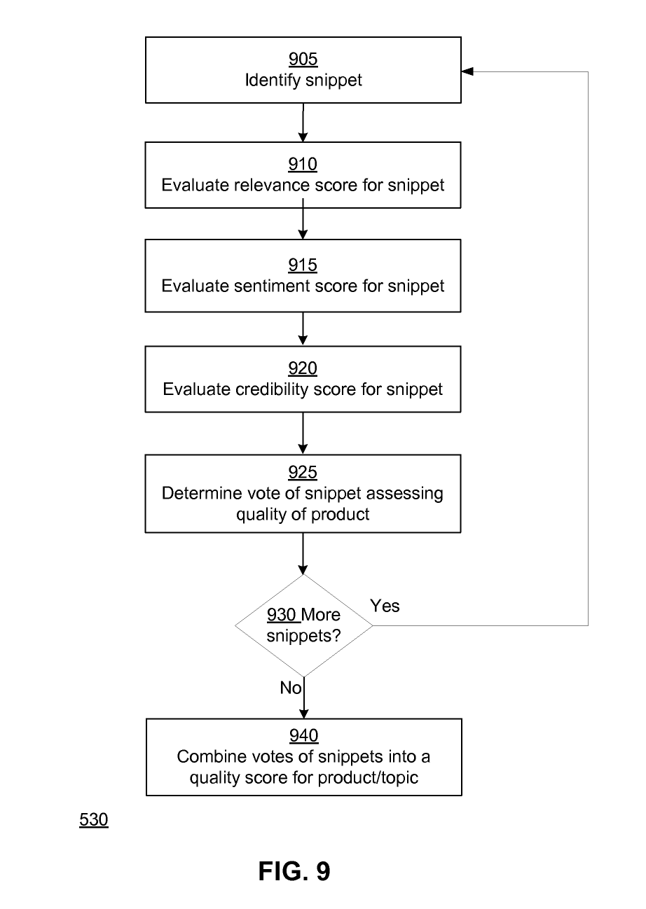

FIG. 9 shows a flowchart of a process for determining 540 the quality score of products/topics used by the quality score computation module 355, in accordance with an embodiment of the invention. The quality score computation module 355 identifies 905 a snippet for computing the quality score. The various scores computed for the snippet, for example, relevance score, sentiment score, and credibility score are combined into a single score for a product/topic that assesses the overall quality of the product/topic. Various embodiments compute the quality score of a product/topic in different ways. One embodiment computes the mean of a set of snippet scores and produces the “average” score of the set. Another embodiment computes the median of a set of snippet scores, produces the “middle” score of the set, and is typically more robust to influence by outlier data.

A good representative score is one that “accurately reflects the general sentiment” as expressed by a variety of indicators. Some of the indicators presented herein include, relevance, sentiment, and credibility of snippets as evaluated in steps 910, 915, and 920. Other indicators include: (1) Recency: Recent snippets can receive more weight than old snippets, particularly for product categories where the technology is rapidly changing, such as electronics goods. (2) Quantity: Products with more snippets relevant to a topic can be considered to be stronger (either positively or negatively, depending on the sentiment of those snippets) than products with fewer relevant snippets. (3) Outliers: While the general sentiment toward a product may be positive, there may also be bits of negative sentiment. These bits should affect the overall score in an appropriate way—i.e., is the negative sentiment a legitimate minority, or just a set of contrarians that have never used the product? (4) Metadata: Metadata about the product can also be used to judge its quality for a specific topic. For example, the price of a product would significantly affect whether a camera is a good deal. While snippets may corroborate this, if the price information is available and the knowledge is available that price information is associated with the “value” topic, this can be very useful information in determining the overall quality score for “value.” Similarly, a single-seat stroller is probably not appropriate for twins no matter how many snippets mention twins. The evaluation of the quality score determines how much each of these factors contributes to the overall score by using an appropriate weight for each factor. In one embodiment, the weights for the factors are different for different categories. For example, the recency factor can contribute more heavily in fast-moving categories, whereas certain metadata may contribute more heavily to certain topics or categories.

Intuitively, each snippet that votes positively with respect to a topic is a vote up, and each that votes negatively is a vote down. The various factors described above for computing the quality score are used to determine 925 the vote using equation (1):

voteₛₙᵢₚₚₑₜ=relevance^{λ1}×sentiment^{λ2}×credibility^{λ3}×2^{-age/λ4} (1)

The parameters λ1, λ2, λ3, and λ4 determine the influence of each of the factors, relevance, sentiment, credibility, and recency contribute to the vote of the snippet. The vote for each snippet is computed while there are unprocessed snippets remaining 930. Another embodiment computes a sum value using equation (2):

voteₛₙᵢₚₚₑₜ=λ1×relevance+λ2×sentiment+λ3×credibility^{λ3}+λ5×2^{-age/λ4} (2)

The sum value computed using equation (2) maps directly to a linear regression problem, where the parameters λ1, λ2, λ3, λ4, and λ5 can be learned directly from the data. Example values of constants used in equation (2) in an embodiment are λ1=0.5, λ2=0.3, λ3=0.2, λ4=0.1, and λ5=0.1. Other embodiments use different techniques of regression estimation, for example, linear, support vector regression, robust regression, etc., and estimate the parameter λ₅ by hand for each category.

In one embodiment, the quality score for each product is computed 940 using equation (3):

$${score}_{product} = {θ}_{1} \times avg ( {vote}_{snippet} ) \times {( 1 + \frac{\vert {vote}_{snippet} \vert}{\vert {vote}_{all} \vert} )}^{{θ}_{2}} \qquad ( 3 )$$

The |S| operator returns the number of elements in the set S and avg(S) is the average of the set S. The factors θ₁ and θ₂ determine how much each of the factors contributes versus the average score of the votes, and may be determined empirically. In one embodiment, θ₁ and θ₂ are determined by a grid search that attempts to minimize the least-squares error (or any loss function) of data that has been manually voted up and down by data curators and/or end users. Example values of the constants used in an embodiment are θ₁=1 and θ₂=1.5. In one embodiment, function avg(voteₛₙᵢₚₚₑₜ) computes the average with outlier removal. For example, the top and bottom K=5% of the votes are eliminated, in an attempt to remove any outliers that may skew the final score up or down.

Different embodiments compute 940 the quality score using techniques including: (1) Determining the statistical mean of the weighted data. (2) Attempting to force the output scoring to a particular characteristic cumulative distribution function (CDF), such as a linear curve, logistic curve, normal distribution, etc. (3) Using a T-test (student's distribution) to predict the maximal value estimate such that the likelihood of observing that distribution is greater than or equal to 90% off the optimal maximum-likelihood estimate. (4) Using a regression technique, in which the input features are a histogram of the percentage of reviews (optionally weighted by credibility), split into score buckets. For example, if there are 10 reviews with score 1 and weight 1, 5 reviews with score 2 and weight 2, 0 reviews with scores 3 and 4, and 1 review with score 5 and weight 10, the resulting feature vector would be (0.333, 0.333, 0, 0, 0.333). This feature vector can be fed to any regression technique, such as linear, polynomial, nonparametric, etc.

### Feedback

The products/topics that are scored are displayed by the user interaction module 360 to a user of the system or a curator who is responsible for ensuring that the system produces high quality results. The user or the curator provides feedback to the system indicating the accuracy of the results computed by the system. The feedback provided by the user is incorporated by the user feedback module 360 to change parameters of the system so as to improve the quality of results. In one embodiment, if the user disagrees with the results computed by the system, the user can specify that the ordering of results within a “best list” is incorrect, by either moving products up or down in the list, or adding them or removing them from the list entirely. This feedback to the system informs the quality scoring stage of the system (and optionally the relevance, sentiment, or credibility analysis as well).

In another embodiment, the user can browse the individual snippets that contributed to the final outcome. This is useful for users to substantiate why a given product was ranked high or low with respect to the topic, but it also gives users an opportunity to correct bad analysis at this stage. When a user sees a snippet that is not relevant to the topic, she can mark it as irrelevant. When a user sees a relevant snippet with the wrong sentiment attached, the user can mark the correct sentiment. And finally, when a user sees a snippet that does not appear to be credible in some way, the user can mark it as suspicious.

The learning and adaptation is implemented differently depending on the type of feedback received. For relevance, sentiment, and credibility analysis, the feedback can be captured as a label and stored with any other labeled data that has been contributed by that user and by other users. The label contains a reference to snippet (snippet id), the user, the time in which the label was created, and the desired output (relevant/not relevant, positive, negative, neutral, credible, and suspicious). The appropriate analysis is retrained according to the model (e.g. Bayesian Networks, Support Vector Machines, Neural Networks, Boosting, etc.) on the new set of data, and an improved model results and is re-run on the inputs.

For the quality score, one embodiment of the update works as follows. When a user votes a product up or down on the ordered list, the information that is stored is the user who made the correction, the time of the correction, the product and topic for which the correction was applied, and the score difference needed to move the product the desired number of places on the list. For example, if product A is rated 78 and product B is rated 80, and the user states that product A should be above product B on the list, the difference stored is 2.1. If the user was to state that A does not belong on the list, a stronger label, not applicable, is stored.

If computation of quality scores is modeled as a regression problem, the approach to incorporate feedback is to relearn the parameters of the regression from the new list as generated by the user votes. Any number of regression techniques will select the set of parameters that minimize the difference between the predicted score and the desired score. An embodiment uses the nonparametric support vector regression technique.

### Display of Results

The user interaction module 360 presents information to the user based on a collection of dynamic web pages built using the information in the normalized data store 305. The information presented to the user is filtered by product specifications (e.g. “Megapixels,” “Battery Life,” etc. for cameras) to match a user's needs. The data generated by data generated by sentiment analysis is used to better match the way users think about products—overall, features, usages and personas.

Users are allowed to limit the products they want to consider in various ways: (1) Product Lists Pages: These pages are lists of products that can start with the complete list of products in a category (such as “Digital Cameras”) and can be filtered down based on price and other attributes (“between 5 and 7 Megapixels”). The user may also mark products that they are interested in for later comparison. (2) Comparison Pages: These pages display products specifications in a grid allowing users to compare them based on the specifications including price. (3) Topic List Pages: For each topic, products can be displayed in order of their product and/or topic rank. This allows users to quickly determine which products match their requirements best without needing detailed knowledge of product specifications. The user is also allowed to transition to a product list page limited to just the topic they have selected.

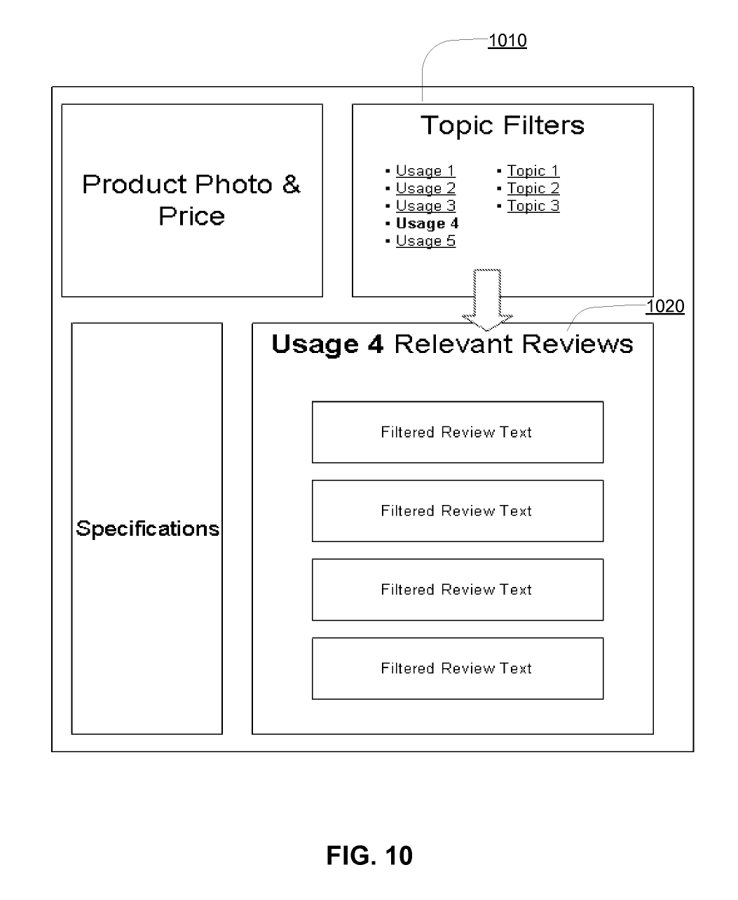

Each product can have a corresponding product details page containing details about the product (photos, price and specifications). FIG. 10 illustrates a user interface in accordance with one embodiment of the invention that allows focused review reading. The user is presented with topics for which the given product has relatively high topic score. These topics may be usage (“Digital Cameras for Vacations”), persona (“for Professionals”), attributes (“with great battery life”), etc. When the user clicks one of the topic names in the topic filter area 1010, the user is shown relevant reviews 1020 comprising a set of reviews that contributed to the topic score of the product for that topic. The phrases and sentences within the review that specifically contributed may be highlighted in a different color to enable users to quickly focus in on the disposition of the review content.

### Alternative Applications

A preferred embodiment of the present invention was described above with reference to the figures. Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the intended purposes, or it may comprise a general-purpose computer(s) selectively activated or reconfigured by a computer program stored in the computer. Such a computer program may be stored in a computer readable storage medium, such as, but is not limited to, any type of disk including floppy disks, optical disks, compact disk read only memory (CD-ROM), magnetic-optical disks, read-only memories (ROMs), random access memories (RAMs), Erasable Programmable Read-Only Memory (EPROMs), Electrically Erasable Programmable Read-Only Memory (EEPROMs), magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A computer implemented method for ranking a plurality of products with respect to a topic, the method comprising:
receiving documents aggregated from multiple online information sources wherein each document contains information on products;
computing snippets of text from the documents, wherein each snippet contains a portion of text describing a product with respect to the topic;
determining an estimate of relevance of each snippet to the topic;
determining an estimate of sentiment of each snippet with respect to the topic; and
determining an aggregate quality score for each products in the plurality of products for ranking the products based on factors associated with each snippet comprising the estimate of relevance of the snippet, the estimate of sentiment of the snippet and the estimate of credibility of the snippet.

2. The computer implemented method of claim 1, further comprising:
determining an estimate of credibility of each snippet.

3. The computer implemented method of claim 1, further comprising:
displaying information used for determining the ranking of products with respect to the topic.

4. The computer implemented method of claim 1, wherein determining an estimate of relevance of each snippet comprises:
identifying a subset of the plurality of snippets wherein each snippet contains terms describing the topic;
computing a feature vector for each snippet wherein the feature vector components are determined based on relevance of the snippet to the topic; and
determining a relevance score for each snippet based on statistical analysis of the feature vectors associated with the snippets.

5. The computer implemented method of claim 4, wherein computing a feature vector for a snippet comprises:
selecting a pattern based on the topic; and
determining a component of the feature vector based on how well the pattern matches the snippet.

6. The computer implemented method of claim 5, wherein the pattern based on the topic comprises at least one of:
a regular expressions of terms describing the topic;
an n-gram with terms describing the topic, wherein the n-gram is selected based on the frequency of occurrence of the n-gram in the plurality of snippets;
an n-gram with terms describing the topic, wherein the n-gram is selected based on the frequency of occurrence of the n-gram in the plurality of snippets and the n-gram is annotated with part-or-speech information;
a boolean predicate based on product metadata;
a scalar value based on the length of the snippet;
number of instances of a phrase in the snippet; and
a measure of proximity of a phrase to the start or the end of the snippet.

7. The computer implemented method of claim 1, wherein determining an estimate of sentiment of each snippet comprises:
identifying a subset of the plurality of snippets wherein each snippet contains terms describing the topic;
computing a feature vector for each snippet wherein the feature vector components are determined based on sentiment described in the snippet; and
determining a sentiment score for each snippet based on statistical analysis of the feature vectors associated with the snippets.

8. The computer implemented method of claim 7, wherein the subset of the plurality of snippets is identified based on relevance of each snippet to the topic.

9. The computer implemented method of claim 7, wherein computing a feature vector for a snippet comprises:
determining a component of the feature vector based on a criteria determining the sentiment described in the snippet.

10. The computer implemented method of claim 9, wherein criteria for determining the sentiment described in the snippet comprises at least one of:
matching of an n-gram with terms describing sentiments, wherein the n-gram is selected based on the frequency of occurrence of the n-gram in the plurality of snippets;
matching of an n-gram with terms describing sentiments, wherein the n-gram is selected based on the frequency of occurrence of the n-gram in the plurality of snippets and the n-gram is annotated with part-or-speech information; and
an estimate of the overall quality of the product; and
an estimate of the credibility of the snippet.

11. The computer implemented method of claim 2, wherein determining an estimate of credibility of each snippet is based on one or more factors, comprising:
a measure of credibility of author of the snippet;
a measure of credibility of the source from where the snippet is obtained;
number of helpfuls and unhelpfuls associated with the snippet; and
the size of a post associated with the snippet.

12. The computer implemented method of claim 1, wherein the factors associated with each snippet further comprise:
an age of the snippet.

13. The computer implemented method of claim 2, wherein the aggregate quality score of the product with respect to the topic is determined as a aggregate value of an estimate of vote corresponding to each snippet, wherein the vote is indicative of the quality of the product with respect to the topic as determined by the snippet.

14. The computer implemented method of claim 13, wherein the vote corresponding to each snippet is determined as a product of terms comprising a relevance score determined based on the estimate of relevance raised to power of a first constant, a sentiment score determined based on the estimate of sentiment raised to power of a second constant, and a credibility score determined based on the estimate of credibility raised to power of a fourth constant.

15. The computer implemented method of claim 14, wherein the product of terms further comprises a term corresponding to a function of the age of the snippet.

16. The computer implemented method of claim 13, wherein the vote corresponding to each snippet is determined as a weighted sum of terms comprising a relevance score determined based on the estimate of relevance raised to power of a first constant, a sentiment score determined based on the estimate of sentiment raised to power of a second constant, and a credibility score determined based on the estimate of credibility raised to power of a fourth constant.

17. The computer implemented method of claim 16, wherein the weighted sum of terms further comprises a term corresponding to a function of the age of the snippet.

18. A computer-implemented system for ranking a plurality of products with respect to a topic, the system comprising:
a computer processor; and
a computer-readable storage medium storing computer program modules configured to execute on the computer processor, the computer program modules comprising:
an aggregation module configured to:
receive documents aggregated from multiple online information sources wherein each document contains information on products;
compute snippets of text from the documents, wherein each snippet contains a portion of text describing a product with respect to the topic;
a relevance analyzer module configured to:
determine an estimate of relevance of each snippet to the topic;
a sentiment analyzer module configured to:
determine an estimate of sentiment of each snippet with respect to the topic; and
a quality score computation module configured to:
determine an aggregate quality score for each products in the plurality of products for ranking the products based on factors associated with each snippet comprising the estimate of relevance of the snippet, the estimate of sentiment of the snippet and the estimate of credibility of the snippet.

19. A computer program product having a computer-readable storage medium storing computer-executable code for ranking a plurality of products with respect to a topic, the code comprising:
an aggregation module configured to:
receive documents aggregated from multiple online information sources wherein each document contains information on products;
compute snippets of text from the documents, wherein each snippet contains a portion of text describing a product with respect to the topic;
a relevance analyzer module configured to:
determine an estimate of relevance of each snippet to the topic;
a sentiment analyzer module configured to:
determine an estimate of sentiment of each snippet with respect to the topic; and
a quality score computation module configured to:
determine an aggregate quality score for each products in the plurality of products for ranking the products based on factors associated with each snippet comprising the estimate of relevance of the snippet, the estimate of sentiment of the snippet and the estimate of credibility of the snippet.
